(19) United States
(12) Patent Application Publication
(10) Pub. No.: US 2021/0226508 A1
(43) Pub. Date: Jul. 22, 2021

(54) ASSEMBLY WITH A PLUG CONNECTOR INSTALLABLE ORTHOGONALLY TO THE INSTALLATION DIRECTION

(71) Applicant: ebm-papst St. Georgen GmbH & Co. KG, St. Georgen (DE)

(72) Inventors: Hassan GHODSI-KHAMENEH, St. Georgen (DE); Johannes HIRT, St. Georgen/Brigach (DE); Lars WÖSSNER, Trossingen (DE); Frank RATH, Rottweil (DE); Claas DRESCHER, Tuttlingen (DE); Christoph BURI, Donaueschingen (DE); Erhard HABERSTROH, Triberg (DE); Patrick SCHNEIDER, Villingen-Schwennigen (DE)

(21) Appl. No.: 17/147,510

(22) Filed: Jan. 13, 2021

(30) Foreign Application Priority Data
Jan. 16, 2020 (DE) 10 2020 100 988.7

(51) Int. Cl. H02K 5/22; H01R 12/51

(52) U.S. Cl. CPC H02K 5/225; H01R 43/02; H02K 2211/03; H01R 12/515

(57) ABSTRACT

An assembly (1) has a housing (10), a plug connector (20), and an electronic subassembly (30). The housing (10) has a guide member (11) and the electronic subassembly (30) has a corresponding mating member (31). The guide member (11) and the mating member (31) determine an installation direction (X) along which the electronic subassembly (30) can be moved into the housing (10). The plug connector (20) has a plug connector housing (21) arranged at the housing (10). At least one contact element (22) is arranged at the electronic subassembly (30). The at least one contact element (22) extends orthogonally to the installation direction (X). The plug connector housing (21) and/or the housing (10), for the respective contact element (22) arranged at the electronic subassembly (30), has a recess (12, 23) that is at least open in the installation direction (X). The respective contact element (22) can be moved through the recess when the electronic subassembly (30) is moved along the installation direction (X) into a final position located in the plug connector housing (21).

### CROSS-REFERENCE TO RELATED APPLICATION

This application claims priority to German Application No. 10 2020 100 988.7, filed Jan. 16, 2020. The disclosure of the above application is incorporating herein by reference.

### FIELD

The disclosure relates to an assembly having a housing, a multi-part plug connector, and an electronic subassembly. The plug-in direction of the plug connector is orthogonal to an installation direction of the assembly. Also, the multi-part plug connector can be fit into the housing along the installation direction during an installation of the subassembly.

### BACKGROUND

Numerous assemblies with housings, electronic subassemblies, and plug connectors are known from the prior art, where the plug connectors, however, must in most cases be tediously contacted with the electronic subassemblies after the electronic subassemblies were installed in the associated housing. In most cases, the procedure is to first install the electronic subassembly in the respective housing, secure the plug connector to the housing and then electrically contact it with the electronic subassembly. This, however, results in an additional installation effort and increased space requirement because the assembly must be configured for better accessibility in order to install the plug connector.

Alternatively, a known procedure of the prior art is to first fasten the plug connector to the electronic subassembly and contact it and then to fit them jointly into the housing. The problem of this approach is that the plug connector must also be connected to the housing to ensure that the plug connector can withstand high mechanical loads and to keep the electronic subassembly free from mechanical forces. This also leads to a relatively high installation effort for the entire assembly.

If the plug connector is already completely or partially fastened to the electronic subassembly and is to project from the housing or be accessible from outside the housing, another problem is that the installation direction of the electronic subassembly into the housing and the plug-in direction of the plug connector must be parallel.

Therefore, the underlying problem of the disclosure is to overcome the disadvantages mentioned above and provide an assembly with a housing, a plug connector, and an electronic subassembly. The plug connector can be installed synchronously with the installation of the electronic subassembly in the housing and with little installation effort.

### SUMMARY

According to the disclosure, an assembly comprises a housing, a plug connector, and an electronic subassembly. The housing has a guide member and the electronic subassembly has a corresponding mating member. The guide member and the mating member determine an installation direction along which the electronic subassembly can be moved into the housing. The plug connector has a plug connector housing arranged at the housing and at least one contact element arranged at the electronic subassembly. The at least one contact element arranged on the electronic subassembly extends orthogonally to the installation direction. The plug connector housing and/or the housing, for a respective contact element arranged at the electronic subassembly, has a recess. The recess is at least open in the installation direction. The respective contact element can pass through the recess and be moved when the electronic subassembly is moved along the installation direction (X) into a final position located in the plug connector housing.

According to the disclosure, an assembly is proposed comprising a housing, a plug connector, and an electronic subassembly. The housing comprises a guide member for ease of installation and fastening the electronic subassembly in position in the housing. The electronic subassembly comprises a corresponding mating member. The guide member and the mating member determine an installation direction along which the electronic subassembly can be moved into the housing. Consequently, the electronic subassembly can be arranged in the housing by a movement along the installation direction. Thus, the subassembly is preferably moved up to an installation position determined by a stop, for example. Further according to the disclosure, the plug connector comprises a plug connector housing arranged on the housing and preferably fastened to it. At least one contact element is arranged on the electronic subassembly. The at least one contact element arranged on the electronic subassembly extends orthogonally to the installation direction. In this way, it preferably determines the plug-in direction of the plug connector, which is accordingly orthogonal to the installation direction. To enable fitting the at least one contact element of the plug connector into the plug connector housing, the plug connector housing and/or the housing for a respective contact element arranged at the electronic subassembly, that is, for each contact element arranged at the electronic subassembly, has at least one recess that is open at least in the installation direction. The respective contact element can be moved through the recess into a final position of the at least one contact element located inside the plug connector housing when the electronic subassembly is moved along the installation direction.

Preferably, the final position of the contact element or the at least one contact element, in the plug connector housing, is determined where the contact elements/the contact element are/is arranged completely in the plug connector housing or in a receiving space specified in the plug connector housing and are/is at the same time located in the predetermined final position where a mating plug member corresponding to the plug connector can be plugged into the plug connector along an installation direction. If the contact element(s) are in their final position, the electronic subassembly is preferably at the same time arranged in its installation position or final position within the housing.

In an advantageous further development, the assembly is a fan assembly. The electronic subassembly comprises, or at least electrically contacts, a stator of an electric motor. The at least the housing encloses the electronic subassembly and/or the electric motor in a cup-shaped manner. Particularly, the housing can be configured to receive at least a portion of the rotor in addition to the stator.

In a likewise advantageous embodiment of the assembly, the plug connector has at least two contact elements arranged at the electronic subassembly to increase the mechanical stability of the plug connector and to ensure, at the same time, that multiple contact elements arranged next to each other are, and remain, insulated from each other. A web is formed between the respective recesses for each of the contact elements that separates the recesses from each other. The respective web is preferably formed by the respective housing or by both housings, depending on whether the plug connector housing and/or the housing comprises the recess. Due to the recesses and the webs arranged therebetween, the recesses are configured as gaps extending preferably in the plug-in direction of the plug connector. At the same time in the installation direction through the plug connector housing, two respective gaps are separated from each other by a web located therebetween. The web, like the recesses, extends orthogonally to the installation direction.

In one variant, that increases the stability of the plug connector and is therefore an advantage, the plug connector housing forms a receiving space mentioned above. The at least one contact element is arranged in its final position and is open in a plug-in direction of the plug connector and due to the at least one recess. Sections of the receiving space are completely closed in the circumferential direction around the plug-in direction and preferably adjacent to the opening. Thus, the recesses do not extend completely to the opening in the plug-in direction. The opening in the plug-in direction is preferably on the side of the plug connector or plug connector housing facing away from the electronic subassembly.

The at least one contact element preferably is an angled or straight soldering pin, which can also be called a pin. At least sections of the soldering pin extend orthogonally to the installation direction. The extension of the soldering pin(s) orthogonal to the installation direction determines the plug-in direction. If a multitude of contact elements is provided, these are preferably configured as a pin strip or PCB connector.

The electronic subassembly preferably comprises a circuit board with conductive paths. The at least one contact element is contacted with a conductive path of the circuit board. If multiple contact elements are provided, these are preferably contacted with one respective conductive path where the respective contact element is electrically connected to other electronic components of the electronic subassembly and a stator, for example.

In another variant, fastening elements are provided on the circuit board where the electronic subassembly can be fastened to the housing. The fastening elements can, for example, be configured as latching hooks or screws that engage respective mating members provided by the housing for this purpose. The fastening elements on the electronic subassembly also allow fastening the at least one contact element in its final position. Thus, the fastening elements of the electronic subassembly fasten the contact elements to the plug connector housing.

An further advantageous development, the plug connector housing is formed in one piece and at least sections thereof are integral with the housing. Accordingly, the plug connector housing and the housing can be made in one piece. An additional insert, which forms the recesses or the webs, respectively, can be provided in one piece or separately.

In an advantageous embodiment of the disclosure, the plug connector further has a frame member where the at least one contact element is received and with which the at least one contact element is fastened to the electronic subassembly and particularly to the circuit board of the electronic subassembly for stabilizing the contact elements on the electronic subassembly. This keeps them in a predetermined position relative to each other and/or on the subassembly. In addition, the frame member, with the at least one contact element in the final position, rests against the respective recess, and/or at least sections thereof extend into the recess by a projection formed for this purpose.

In one variant where the frame member extends into the recess by means of a projection. The respective contact element can be stabilized in its associated recess by the projection or the projection can close sections of the recess. Thus, the frame member integrally forms a lid that covers at least sections of the recess(es). Thus, the receiving space of the connector(s) is separated and preferably sealed from an interior space where the housing in which the electronic subassembly is accommodated. In this way, a lid for covering the recess(es) in the plug-in direction can be provided. Thus, each of the recesses is preferably covered by the lid formed in this manner. For example, the frame member can form a projection for each recess. The projection extends into the associated recess and closes the recess completely or at least in the plug-in direction to the electronic subassembly. Alternatively, a flat surface of the frame member can overlap the recess(es) and directly abut the housing that forms the recesses. In this way, it closes these recesses completely or at least in the plug-in direction to the electronic subassembly. It is a further advantage if the lid formed in this manner tightly closes the recess, particularly watertight, for which purpose sealing elements can be provided on the lid. The interior space of the housing or at least a section of the interior space of the housing can thus be sealed from the environment and particularly from the receiving space of the plug connector.

If a frame member with a projection is present, it can determine a position of the electronic subassembly in the circumferential direction around the installation direction and determine the orientation of the subassembly relative to the housing. In one variant, the frame member forms at least one projection for this purpose. The projection extends into a recess in the final position of the contact element. The projection and the recess, into which the projection extends, determine an orientation or rotation of the electronic subassembly relative to the housing in the circumferential direction around the installation direction.

Alternatively, the guide member and the mating member can determine the orientation or rotation of the electronic subassembly relative to the housing in the circumferential direction around the installation direction. To this end, the guide member and the mating member can comprise a corresponding asymmetry of their cross sectional shapes or a projection and a corresponding groove, for example. Thus, the electronic subassembly can only be moved in a specific orientation along the installation direction.

In addition, a further development is advantageous where the plug connector projects from the housing radially to the installation direction and/or in the installation direction.

Likewise advantageous is a configuration of the assembly where the at least one contact element projects from the housing, at least in its final position.

The basic idea of the disclosure is not just to include an embodiment where all contact elements are arranged at the electronic subassembly, but also a variant, for example, where only a part of the contact elements of the plug connector are arranged at the electronic subassembly.

All features disclosed above can be combined in any desired manner, where technically feasible and not contradictory.

Other advantageous refinements of the disclosure are characterized in the dependent dams and will be described in greater detail in the following in conjunction with the description of the preferred embodiment of the disclosure, with reference to the figures.

### DRAWINGS

Other advantageous embodiments of the disclosure are designated in the dependent claims and/or are described in further detail below along with the description of the preferred embodiment of the disclosure with reference to the figures. In the figures:

FIGS. 1a-1c are schematic perspective and elevation views of a first variant of an assembly.

FIGS. 2a-2c are schematic perspective and cross-section views of a second variant of an assembly.

FIGS. 3a-3b are perspective schematic views of a third variant of an assembly.

### DETAILED DESCRIPTION

The figures are schematic for illustration. Like reference numbers in the figures indicate like functional and/or structural features.

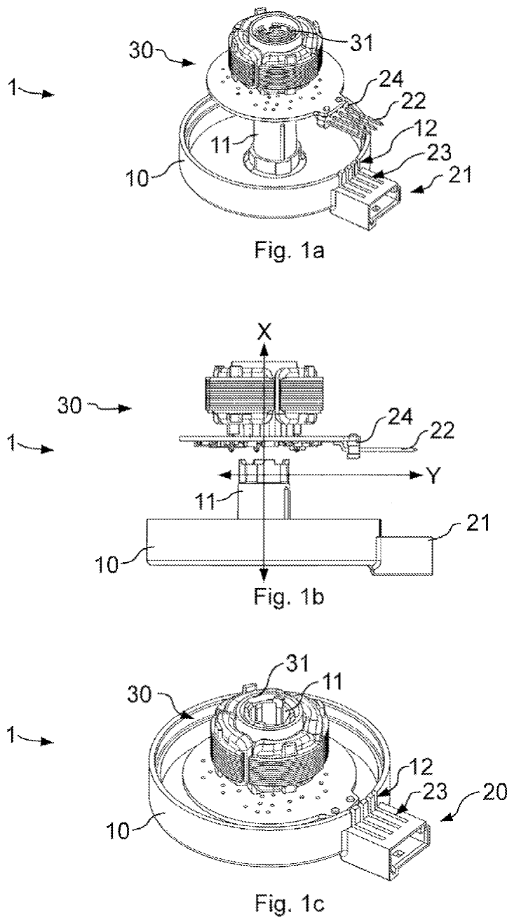

FIGS. 1a to 1c show various views of a first variant of an assembly according to the disclosure. FIGS. 1a and 1b show a disassembled or exploded view of the assembly 1, where the electronic subassembly 30, with the four fastened contact elements 22, has not yet been moved along the guide member 11 into the housing 10. To this end, the electronic subassembly 30 has a tube-shaped mating member 31. Thus, it can be arranged around the peg- or cylinder-shaped guide member 11 and moved along the guide member 11 in the installation direction X into the housing 10.

The plug connector 20 includes a plug connector housing 21, integrally formed with the housing 10, a frame member 24, and the four contact elements 22. The contact elements are received in the frame member 24 and fastened to the electronic subassembly 30 using the frame member 24. In addition to a stator of an electric motor, the electronic subassembly 30 includes a circuit board, where the frame member 24 is fastened, with conductive paths where the contact elements 22 are contacted.

As is particularly well visible in FIG. 1b, the contact elements 22 project in the plug-in direction Y or orthogonally to the installation direction X from the housing 10.

To install the multi-part plug connector 20 when installing or moving the electronic subassembly 30 in(to) the housing 10 without having to introduce additional installation steps to do so, it is envisaged in the variant shown that, for each contact element 22, both a recess 12 is provided in the housing 10 and a recess 23 is provided in the plug connector housing 21, or a recess with a first section 12 and a second section 23 is provided. Accordingly, when the electronic subassembly 30 is moved, the contact elements 22 can be moved along the installation direction X through the recesses 12, 23 into the receiving space formed by the plug connector housing 21 where they are completely accommodated in the final position as shown in FIG. 1c.

It is therefore possible to produce the housing 10 integrally and in one piece with the plug connector housing 21, for example, in an injection molding process. Also, it can be joined in a single installation movement or by a single installation step with the electronic subassembly 30, while at the same time installing the plug connector 20.

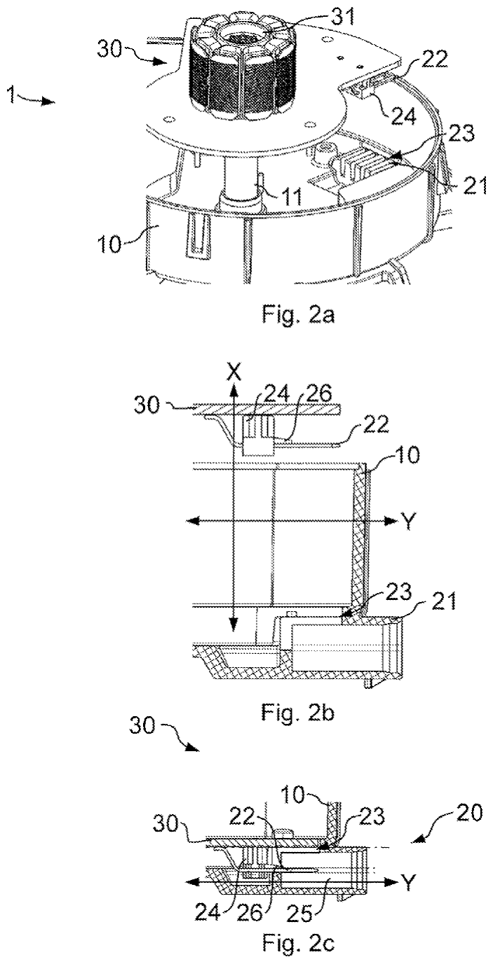

The FIGS. 2a to 2c illustrate an alternative embodiment, where FIGS. 2b and 2c each show a cross section through the assembly 1, which particularly runs through the plug connector 20 or its plug connector housing 21. The major difference compared to the variant from FIGS. 1a to 1c is that the plug connector 20 is formed closer to the guide member 11 in the radial direction relative to the peg- or cylinder-shaped guide member 11. Thus, the contact elements 22 do not project beyond the housing 10 in the plug-in direction Y. Therefore, a recess formed in the plug connector housing 21 is provided for a respective contact element 22, which recess extends completely within the housing 10.

In the sectional view shown in FIG. 2c, the contact elements 22 are shown in their final position. The electronic subassembly 30 is also in its final or installation position. In addition, the receiving space 25 of the plug connector 20 where the contact elements 22 extend can be seen in the sectional view.

In the variant shown in FIGS. 2a to 2c, the frame member 24 further forms a projection 26 for each contact element 22. The projection extends along the respective contact element 22 through the respective recess 23 and gives additional support to the respective contact element 22 in the installation direction X. Thus, each contact element 22 is stabilized and supported along the installation direction X by the plug connector housing 21 to one side and by the respective projection 26 to the opposite side.

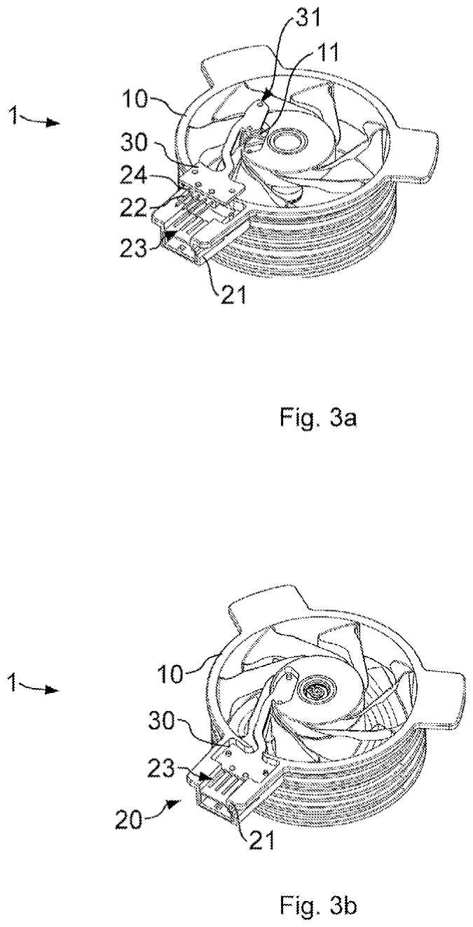

FIGS. 3a and 3b show another embodiment according to the disclosure where housing 10 is configured as an outer ring and as an inner cup integrally connected by webs. The electronic subassembly 30 includes a circuit board with conductive paths formed thereon. The circuit board extends along one of the webs from the inner cup to the outer ring. In this manner, it electrically contacts the plug connector 20 arranged at the outer ring with the inner cup or another electrical subassembly arranged at the inner cup.

The plug connector housing 21 is formed integrally with the housing 10, and not only do the contact elements 22 extend beyond the housing 10 but the entire plug connector 20 is arranged outside the housing 10. Instead, a section of the electronic subassembly 30 projects from the housing 10 into the plug connector 20.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An assembly comprising a housing, a plug connector, and an electronic subassembly,
the housing has a guide member and the electronic subassembly has a corresponding mating member,
the guide member and the mating member determine an installation direction along which the electronic subassembly can be moved into the housing,
the plug connector further comprising a plug connector housing arranged at the housing and at least one contact element arranged at the electronic subassembly,
the at least one contact element arranged on the electronic subassembly extends orthogonally to the installation direction, and
the plug connector housing and/or the housing, for a respective contact element arranged at the electronic subassembly, further comprises a recess, which is at least open in the installation direction, through which the respective contact element can be moved when the electronic subassembly is moved along the installation direction into a final position located in the plug connector housing.

2. The assembly according to claim 1, wherein the assembly is a fan assembly, the electronic subassembly further comprises, or at least electrically contacts, a stator of an electric motor, and the housing encloses at least the electronic subassembly and/or the electric motor in a cup-shaped manner.

3. The assembly according to claim 1, wherein the plug connector further comprises at least two contact elements arranged at the electronic subassembly and wherein a web is formed between the respective recesses for a respective contact element, the web separates the recesses.

4. The assembly according to claim 1, wherein the plug connector housing forms a receiving space where the at least one contact element is arranged in its final position and which space is open in a plug-in direction of the plug connector and through the at least one recess, and wherein sections of the receiving space are completely closed in the circumferential direction around the plug-in direction.

5. The assembly according to claim 1, wherein the at least one contact element is an angled or straight soldering pin, at least sections of which extend orthogonally to the installation direction.

6. The assembly according to claim 1, wherein the electronic subassembly further comprises a circuit board with conductive paths and the at least one contact element is contacted with a conductive path of the circuit board.

7. The assembly according to claim 6, wherein fastening elements for fastening the electronic subassembly to the housing are provided on the circuit board.

8. The assembly according to claim 1, wherein the plug connector housing is formed in one piece and at least in sections integral with the housing.

9. The assembly according to claim 1,
wherein the plug connector further comprises a frame member where the at least one contact element is accommodated and with which the at least one contact element is fastened to the electronic subassembly,
the frame member, with the at least one contact element in the final position, rests against the respective recess and/or at least sections thereof extend into said recess.

10. The assembly according to claim 9,
wherein the frame member forms at least one projection that extends into a recess when the contact element is in the final position, and
the projection and the recess, into which the projection extends, determine an orientation of the electronic subassembly relative to the housing in the circumferential direction around the installation direction.

11. The assembly according to claim 1,
wherein the guide member and the mating member determine an orientation of the electronic subassembly relative to the housing in the circumferential direction around the installation direction.

12. The assembly according to claim 1,
wherein the at least one contact element projects from the housing at least in its final position.
